(19) United States
(12) Patent Application Publication
(10) Pub. No.: US 2013/0213100 A1
(43) Pub. Date: Aug. 22, 2013

(54) Method and apparatus for electronic lock system

(71) Applicant: Shy Cohen, Yokneam Hamoshava (IL)

(72) Inventor: Shy Cohen, Yokneam Hamoshava (IL)

(21) Appl. No.: 13/811,288

(22) PCT Filed: Jul. 25, 2011
(86) PCT No.: PCT/IB2011/053303

§ 371 Date: May 1, 2013

Related U.S. Application Data
(60) Provisional application No. 61/367,420, filed on Jul. 25, 2010.
(60) Provisional application No. 61/491,269, filed on May 30, 2011.

(51) Int. Cl. E05B 47/06

(52) U.S. Cl. CPC E05B 47/0611
USPC 70/283.1

(57) ABSTRACT

A key and a lock, the lock may a power receiving circuit arranged to receive from a key power that facilitates an operation of the lock during a lock activation period of a limited duration, wherein the supply of power is triggered by a detection of a proximity between the key and the lock; a lock logic circuit, powered by power receiving circuit, arranged to participate, during the lock activation period, in an execution of at least one operation selected from a group consisting of a key management operation and a lock opening attempt; and a lock mechanical module arranged to participate in a lock attempting attempt.

### RELATED APPLICATIONS

This application claims priority from U.S. provisional patent Ser. No. 61/367,420 filing date Jul. 25, 2011 and from U.S. provisional patent Ser. No. 61/491,269 dated May 30, 2011, each of which is incorporated herein in its entirety.

### BACKGROUND OF THE INVENTION

Securing one's possessions or spaces has long been a concern of people throughout the world. Thus, major attempts have been invested in finding ways to secure them.

The idea of key and lock started as early as 4,000 years ago with a pin lock where a cylinder of wood with a hole drilled through its axis was the key. Improvements included increasing the number of pins to increase security, and changing the orientation of the pins to allow the key to provide the unlocking force instead of a rope. Most mechanical modern locks still use a combination of a cylinder and a key that should be recognized by the cylinder. However, this scheme has multiple problems. A person typically carries a number of keys wherein each key is appropriate for opening a specific lock, such as the person's home, office, bike, car, or the like. Such keys, in addition to becoming a burden to carry, are also a burden to secure against being lost or stolen. In some cases people carry unused keys, and then forget what the keys were intended for, throw them away and then if and when the need arises, the keys are not available anymore. Other problems relate to the owner of a lock, whether other people carry keys for the lock or not. The owner has to keep spare keys for the lock, in case a legitimate key-holder loses his key, or a new person has to be given a key. Such spare keys also have to be secured, preferably in a non-guessable location. Moreover, if a key is given to a person, taking the key back from the person does not ensure that the person did not duplicate the key prior to returning it, and thus still has access to the lock. Yet another problem is that when a lock is replaced for some reason, or a person moves to another place, new keys have to be produced and distributed to all users. A lost or stolen key is also a major problem the cylinder and all keys have to be replaced and re-distributed to legitimate holders.

Another type of locks and keys system is common in large offices, hotels or other multi-lock environments, and includes card-like keys and suitable locks. The cylinder and the cards are coded at one or more central locations, such as the hotel's reception, and are re-coded as needed, for example in order to disable the key held by a previous guest and enable the key of a new guest.

However, this arrangement requires central management mechanism, as well as cabling for carrying both electrical power and data to each individual lock, so that information regarding the new codes can be transferred to the keys.

Another known type of lock is called a keypad lock. A keypad lock comprises a set of buttons usually numbered 0, 1 . . . 9, so that after a user presses or pushes the right button combination a pin locking the cylinder is released, or another mechanic mechanism is used, so that the lock can be opened

Other types of locks use a biometric sensor, such as a fingerprint scanner or an iris scanner. When a person wants to open the lock, he or she brings his relevant body part such as the finger or the eye to an appropriate scanner, so that the scanner can detect his or her biometric signature. The signature is then compared to a signature collection, and if found to belong to an allowable person, the lock unlocks, for example by releasing a pin in the cylinder.

There is therefore a need in the art for a novel lock and key system that will overcome the drawbacks of the prior art. A single key should be useful for opening multiple locks so a person will not have to carry many keys; the system should enable a lock and key to be changed so that keys that are not authorized any more will not enable opening the lock. In addition, there should be way to un-authorize one or more keys without changing all other keys or replacing the lock.

### SUMMARY OF THE INVENTION

According to an embodiment of the invention a lock is provided. The lock may include a power receiving circuit arranged to receive from a key power that facilitates an operation of the lock during a lock activation period of a limited duration, wherein the supply of power is triggered by a detection of a proximity between the key and the lock; a lock logic circuit, powered by power receiving circuit, arranged to participate, during the lock activation period, in an execution of at least one operation selected from a group consisting of a key management operation and a lock opening attempt; and a lock mechanical module arranged to participate in a lock attempting attempt.

The lock activation period is short may not exceed few seconds, a minute, half a minute, 20 seconds, 10 seconds and the like.

The lock logic circuit may be arranged to determine, based on information retrieved from the key and information stored at the lock, whether the key is authorized to open the lock; and allow the key to open the lock if determining that the key is authorized to open the lock.

The lock logic circuit may be arranged to allow the lock mechanical module to be opened after the lock logic determined that the key is authorized to open the lock; wherein the lock mechanical module may be arranged to open the lock in response to a predefined movement of the key.

The lock logic circuit may be arranged to instruct the lock mechanical module to be mechanically linked to the key after determining that the key is authorized to open the lock.

The power receiving circuit may be arranged to receive power from the key by inductance.

The key management operation may be either one of resetting the lock, defining the key as a master key, defining another key as an additional master key, defining another key as an authorized key that is not another master key, revoking an authorization of another key to open the lock, revoking a definition of another key to be a master key.

The lock logic circuit may be arranged to initiate a key management selection operation by sensing that a key that is defined as a master key was inserted into a keyhole of the lock and removed from the key hole at least twice; wherein the key management selection operation may be either one of resetting the lock, defining another key as an additional master key, defining another key as an authorized key that is not another master key, revoking an authorization of another key to open the lock, revoking a definition of another key to be a master key,

The lock may include a lock status indicator arranged to provide a lock status indication by the lock, wherein the lock status indication may be either one of an audio lock status indication and a visual lock status indication.

The lock may include a power reservoir arranged to power the lock logic circuit after a termination of a supply of power from the key and during the lock activation period.

According to an embodiment of the invention a method for opening a lock is provided and may include receiving, from a key and by the lock, that facilitates an operation of the lock during a lock activation period of a limited duration; and participating, during the lock activation period, in an execution of at least one operation selected from a group consisting of a key management operation and a lock opening attempt.

The lock activation period is short may not exceed few seconds, a minute, half a minute, 20 seconds, 10 seconds and the like.

The lock opening attempt may include determining, based on information retrieved from the key and information stored at the lock, whether the key is authorized to open the lock; and allowing the key to open the lock if determining that the key is authorized to open the lock.

The method may include opening the lock if determining that the key is authorized the open the lock and if detecting that the key performed a predefined movement after being authenticated.

The method may include providing a mechanical link between the key and a lock mechanical portion thereby allowing the key to open the lock mechanical portion, if determining that the key is authorized to open the lock.

The method may include receiving power from the key by inductance.

The key management operation may be either one of resetting the lock, defining the key as a master key, defining another key as an additional master key, defining another key as an authorized key that is not another master key, revoking an authorization of another key to open the lock, revoking a definition of another key to be a master key.

The method may include initiating a key management selection operation by sensing that a key that is defined as a master key was inserted into a keyhole of the lock and removed from the key hole at least twice; wherein the key management selection operation may be either one of resetting the lock, defining another key as an additional master key, defining another key as an authorized key that is not another master key, revoking an authorization of another key to open the lock, revoking a definition of another key to be a master key,

The method may include providing a lock status indication by the lock, wherein the lock status indication may be either one of an audio lock status indication and a visual lock status indication.

The method may include providing power by a power reservoir to a lock logic circuit after a termination of a supply of power from the key and during the lock activation period.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates an embodiment of the lock and key system;

FIG. 2 illustrates embodiment of a process for retrieving codes from the key and deciding whether a key is authorized for the lock;

FIG. 3 is a flow chart of a method for activating an electronic lock and key system, according to an embodiment of the invention;

FIG. 4 illustrates a lock and a key according to an embodiment of the invention;

FIG. 5 illustrates a lock 510 and a key according to another embodiment of the invention;

FIG. 6 illustrates a method for opening a lock according to an embodiment of the invention; and

FIG. 7 illustrates a control element and a lock according to an embodiment of the invention.

### DETAILED DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views.

Because the illustrated embodiments of the present invention may for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

Subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The disclosed method and apparatus enable an owner of an electronic key to use the key for opening an electronic lock and to manage the lock to enable, disable, authorize and cancel authorization of other keys to open a lock.

The authorization of a lock in association with a specific key is determined by a sequence of data request retrieval unique to the lock, wherein the read data is unique to the key, thus creating unique combination. Therefore, each lock may be activated by multiple keys optionally having different authorizations, and each key may activate multiple lock, also with various authorizations. The key may alternatively be a body part such as a finger or an iris, or a keypad.

One aspect of the disclosure relates to a method for activating a lock, the method comprising the steps of: the lock retrieving information from an opening element according to program or data stored within the lock; the lock determining according to the information retrieved from the opening element and information stored within the lock whether the opening element is authorized for activating the lock; and if the opening element is authorized for activating the lock, the lock issuing a signal to a mechanic control of the lock, so as to enable the lock to be activated. The method can further comprise a step of placing the opening element and the lock so as to enable communication between the lock and the opening element. Within the method, the lock can be operated by an opening element subject to performing a process of activating the lock after reset. Within the method, the lock is optionally an electronic lock. Within the method, the, opening element is optionally a key having a storage, or a body part or a keypad. The opening element optionally comprises a combination of two or more elements, each selected from the group consisting of: a body part, a keypad, and a key having a storage.

The method optionally comprises a step of determining whether the lock is in reset mode. The method can further comprise a step of supplying power from the lock to the opening element or a step of supplying power from the opening element to the lock. The method optionally comprises the steps of: determining whether the opening element was used for opening the lock; if the opening element was not used for opening the lock, determining whether the opening element is a master opening element for the lock; and if the opening element is a master opening element of the lock, executing a control operation.

The control operation is optionally selected from the group consisting of: resetting the lock; creating a new master opening element; authorizing an opening element to open the lock; disabling an authorization for an opening element from opening the lock; authorizing a disabler opening element; and disabling an opening element from opening the lock using a disabler opening element. Within the method, executing the control operation optionally comprises performing a sequence of one or more actions, each of the one or more actions selected from the group consisting of: placing a first opening element and the lock so as to enable communication between the first opening element and the lock; opening the lock; removing the opening element without opening the lock, placing a master opening element and the lock so as to enable communication between the master opening element and the lock; placing an authorized opening element and the lock so as to enable communication between the authorized opening element and the lock; and placing a disabler opening element and the lock so as to enable communication between the disabler opening element and the lock. The sequence of actions is optionally required to be completed during a predetermined period of time. Within the method, activating the lock can refer to opening the lock, closing the lock, starting an operation, or stopping an operation.

Another aspect of the disclosed invention relates to a lock system, the system comprising one or more locks and one or more opening elements, each lock comprising: a lock mechanic control, the lock mechanic control being in locked position or in open position; a lock communication system for sending requests to retrieving information from the opening elements according to information or program stored within the lock; a lock storage for storing information characterizing the lock and information retrieved from the opening elements; and a lock processor for comparing the information retrieved from the opening elements to information stored within the lock storage, for sending open commands to the lock mechanic control, and for performing control operations. Each opening element optionally comprises: storage for storing information characterizing the opening element; and an opening element communication system for retrieving information from the opening element storage. The lock is optionally an electronic lock. Within the lock system the lock optionally further comprises a scanning element for retrieving information from the opening element, or a lock signaling device, for issuing one or more indications related to a state of the lock. The opening element can further comprise an opening element signaling device, for issuing one or more indications related to a state of a lock the opening element is connected to.

The lock signaling device or the opening element signaling device can be a visual signal generator or an audio signal generator. Within the lock system, the lock storage optionally stores one or more data structures selected from the group consisting of: a master opening element data structure for storing information about one or more master opening elements for the lock; an authorized opening element data structure for storing information about one or more opening elements for opening the lock; an opening element with disablers data structure for storing information about one or more first opening elements and one or more disablers for the first opening elements; and a disabled opening elements data structure for storing information about one or more disabled opening elements. The lock can be in a reset mode, normal mode, or control mode. Within the lock system, the opening element storage device can be a write once read only memory. Within the lock system, the opening element is optionally a key having a storage, a body part or a keypad. The body part is optionally a finger or an iris. Within the lock system, the opening element optionally comprises a power supply.

Yet another aspect of the disclosure relates to an opening element comprising first information, for activating a lock comprising second information, the lock being activated if a part of the first information was previously stored within the lock, wherein the part is determined by the second information. The opening element can have one or more authorizations for the lock, the authorizations optionally selected from the group consisting of: a master key; a regular key; a disabler key; and a disabled key. The opening element optionally comprises a power source. The opening element is optionally a body part or a keypad.

The disclosed subject matter comprises an electronic lock and key system. The electronic lock comprises a lock device mechanic control for controlling an actual physical lock, a lock device storage device, a lock device processor and a lock device communication system. The electronic key comprises a power system, a key storage device and a key communication system. The key storage device comprises read-only information characterizing the key. The lock storage device comprises read-only information characterizing the lock, and sets of characteristic codes for various purposes, such as combinations characterizing regular keys, master keys, disabler keys, and the like, wherein each set is associated with a specific key. The sets of characteristics are stored and retrieved during operation of the lock. In regular operation mode, when a key is inserted into, or is otherwise brought in touch with the lock, the power supply of the key activates the lock processor. The lock processor then reads a sequence of one or more items from the key storage and determines whether an open command should be sent to the lock device mechanic control to enable unlocking the lock. When an open signal is sent, a mechanical mechanism is operated, for example by releasing a pin and thus enabling the key operator to open the lock for a predetermined time.

The reading sequence is unique to the specific lock, and the data or other information read from the key is significantly unique, i.e. the probability that two different keys will have the same codes for a specific lock can be made as low as required, depending on the specific implementation used. Thus, the matching between the specific lock and the specific key is determined. In addition to the normal operation mode, the lock can be in control mode in which control operations can be performed by executing a sequence of operations unique for each control operation.

The control operations enable resetting the lock so that all keys are disabled and every potential master key can become a master key, creating a master key, authorizing a key to open the lock, disabling a key from opening the lock using the key, disabling a key from opening the lock using a disabler key, and optionally additional operations. The initial state of the lock, which can also be resumed later on, is reset mode in which every key can be made a master of the lock.

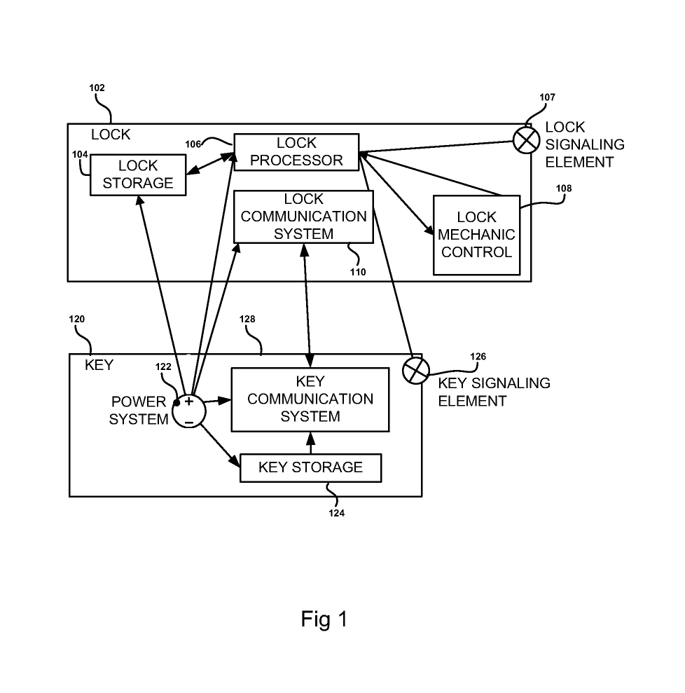

Referring now to FIG. 1, showing a block diagram of an embodiment of the lock and key system. The lock device, generally referenced 102 comprises a lock mechanic control 108 which can be in a locked position or in an open position, a lock storage device 104 storing data characterizing the lock and data or other information related to keys having one or more authorizations for the lock, a lock processor 106, a lock communication system 110 for sending requests and receiving data from a key communication system, and an optional lock signaling element 107. The key system, generally referenced 120 comprises a power supply 122, a key storage device 124 which contains stored data characterizing the key, a key communication system 128 for receiving requests and supplying data or other information retrieved from key storage 124 to lock communication system 110, and an optional key signaling element 126. The electronic lock preferably looks like an ordinary cylinder lock, optionally with a handle located in the inner side of the lock and the electronic key may look like a car key, or any other key which is thick enough to hold a memory device, power supply, and optionally an indicator such as a led. However, the key does not have to comprise external indicator, teeth, or another mechanism such as a traditional key.

In another embodiment, the key may appear similarly to a credit card, optionally with one end thickened, and the lock looks like a traditional hotel-room lock, having a keyway into which the card-like key is inserted. The key storage may be any programmable once read-only memory device, such as Erasable Programmable Read Only Memory (EPROM). Power supply 122, also located on the key device, is preferably a battery, limited only by the physical size of the key. In an embodiment, the battery is a 5 volt lithium battery. Key signaling element 126 or lock signaling element 107 are optionally visual signal generators such as colored LEDs. Optionally, two or more lights having different colors are used, in order to provide a status indication to the key operator. For example, when an Open signal is issued, a green light goes on, while a mismatch between an introduced key and the lock is indicated by a red light. Optionally, a third color or blinking of lights may be used for indicating that the lock is in control mode or in reset mode, or that the battery is low. These statuses are explained in detail below. In another embodiment, key signaling element 126 or lock signaling element 107 is an audio signal generator, such as an electrical buzzer issuing an alarm or recorded or synthesized voice. Lock mechanic control 108 is preferably an electro magnet which when in open mode is holding a pin of the cylinder thus enabling a user to open the lock, wherein in closed mode the pin resides within a dedicated socket in a frame or another element surrounding the lock. The mechanic lock control can preferably receive electric signals in order to hold or release the pin. Other embodiments include magnetic or any other mechanisms which can toggle between open and lock modes. Mechanic control 108 is normally in a locked state, meaning that even when a key is inserted into the lock device, the lock does not open. Mechanic control 108 opens only when an “open” signal is received from lock processor 106. Lock processor 106 can be any microcontroller which can physically fit into the key, such as PIC16, manufactured by Microchip Technology of Chandler, Arizona, USA (www.microchip.com). In an embodiment, the lock storage device is a combination of random access memory (RAM), non volatile memory, and programmable read-only memory.

Lock device communication system 110 and key communication system 128 are two components that transfer a request from lock processor 106 to read data from key storage 124, execute the read request and transfer the data read to the lock processor 106. An embodiment of lock communication system 110 and key communication system 128 comprises a set of connectors and wires that enable the processor to directly access key storage 124. Alternatively, Radio Frequency Identification (RFID), wireless or parallel-to-serial and serial-to-parallel adaptors may reside in lock communication system 110 and in key communication system 128, so that the connection between them may be either wired using physical contact or wireless using air transmission.

Key communication system 128 optionally includes a copy protection mechanism which disables reading more than predetermined amount of data during a predetermined period. The protection can be achieved using a real time clock and a counter that counts the number of read requests and masks or changes the data transmitted from the key communication system. Thus an intruder trying to duplicate the key storage will fail. In order to operate the key and lock mechanism, key 120 is brought in touch with or connected to lock 102, by inserting the key into a keyway within the lock, by attaching the key to the lock, or any other way, causing wired, wireless, or contact communication.

Power system 122 of key 102 provides electrical power to the components of the key and the lock device, including lock storage 104, key storage 124, and when the system is operated, also to lock device communication system 110 and key communication system 128. Once the key and the lock are in contact, processor 106 controls lock communication system 110 which communicates with the key via key communication system 128. Processor 106 accesses and retrieves from lock storage 104 sequences of codes used for identifying master keys, sequences of codes identifying regular keys, or sequences of codes identifying disabler keys for previously authorized keys.

Then, according to the retrieved codes, codes identifying the key are retrieved through lock communication system 110 and key communication system 128 from key storage 124. Processor 106 compares the codes retrieved from key storage 124 with codes stored on lock storage 104. If processor 106 determines that the codes retrieved from key storage 124 match codes stored on lock storage 104, i.e. the key matches the lock, then processor 106 generates signals for lock mechanic control 108 to open. Processor 106 also optionally generates and sends signals to key signaling element 126 and to lock signaling element 107.

Key communication system 128 may have a counter that enables the key to receive only a limited number of requests, or to send only a predetermined number of codes, after which the key device for a predetermined period of time, in order to protect the key from being copied.

In an embodiment of the disclosed subject matter, the data to be retrieved from the key device is determined by executing a program stored in the lock device rather than by reading raw data from storage of the lock device.

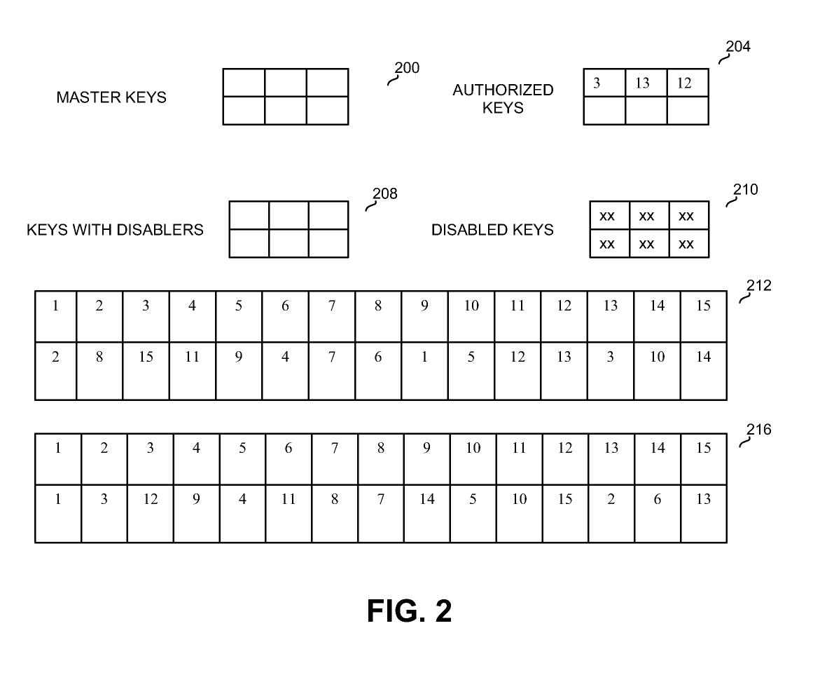

Referring now to FIG. 2, illustrating embodiments of the process for retrieving codes from the key and deciding whether a key is authorized for the lock. FIG. 2 illustrates an embodiment of lock storage 104 comprising master key table or other data structure 200, regular key table or other data structure 204, disabler key table or other data structure 208, optional disabled keys table or other data structure 210, and main table or other data structure 212, and key storage comprising table or other data structure 216. Tables 212 and 216 preferably comprise between a few and a few hundreds or thousands of entries, the entries preferably comprising integer numbers. Data structures 200, 024, 208, 210 may have a limited number of entries, meaning that a limited number of keys can be used, but they can also be expandable by processor 106 to accommodate any required number of keys. In one embodiment, lock processor 106 of FIG. 1 access cell number 1, or any other predetermined cell in main table 212 of lock storage, and finds there the number 2. It then retrieves through lock communication system 110 and key communication system 128 the contents of cell number 2 of key storage main table 216, which is 3.

Processor 106 then accesses cell number 3 in main table 212 of lock storage and finds there the number 15, accesses cell number 15 in key storage main table 216 and finds there the number 13, and then accesses cell number 13 in main table 212 of lock storage and finds there the number 3, accesses cell number 3 in key storage main table 216 and finds there the number 12. The sequence of 3, 13, and 12 is then compared against all rows in regular key table 204. In a generalized embodiment of the exemplary process, key storage 124 comprises a table of integer numbers. Lock storage 104 stores one or more integer numbers L₁, L₂ . . . Lₙ, and one or more read-only tables T₁, T₂ . . . Tₘ. Lock processor 106 reads from key storage the value in cell L₁, named K₁, then determines T₁[K₁], then optionally determines T₂[T₁[K₁]] and so on until Tₘ[tₘ₋₁[ . . . T₁[K₁]]], according to the number of tables, m. The last determined number is stored. The process repeats n times, and the n resulting numbers are the signature of the specific key in association with the specific lock, which are compared to the tables in normal operation mode or stored in the relevant table if the key is a master key, an authorized key, a disabled key or a key with disabler, or are. The security level of the system, i.e. the probability that a random key will provide the same indications as another key previously associated with the key, is dominated by the number of readings made from the key, n, the number of tables within lock storage, m, and the number of entries of the lock tables and the key tables.

If the lock is in regular state and a row comprising these numbers is found in the authorized keys table 204 or in master keys table 200, an open command is sent to lock mechanic control 108. When the lock is in another state, according to the state and the process executed process, the retrieved set of numbers is compared to the rows of master key table 200, disabled key table 210 keys with disabler table 208 or authorized keys table 204. In another embodiment, main table 212 is replaced with multiple tables and optionally with a mathematical function such as a set of additions and multiplications. The tables and the mathematical function should produce a deterministic result, i.e. each time the lock retrieves a set of numbers from the key, and the same set is received. It will be apparent that the sequence of numbers may count at least two numbers, but may be as long as desired for enhanced security. A person skilled in the art will appreciate that additional embodiments can be designed for retrieving a sequence unique for each lock, of numbers from the key storage, for matching the key against one or more of the tables, or for storing the key characteristic in one of the tables. Key with disablers table 208 comprises two rows for each key, one row comprising the codes associated with a first key, and the other row comprising the codes associated with a second key, which when used in the appropriate state disables authorization for the first key. When a key is disabled using a disabler key and table 208, its codes are deleted from authorized keystable 204. It will further be appreciated that additional or different tables or additional or different data structures can be used for storing and determining keys authorized for specific purposes or having specific limitations such as maximal number of times to be used, without deviating from the spirit of the present invention.

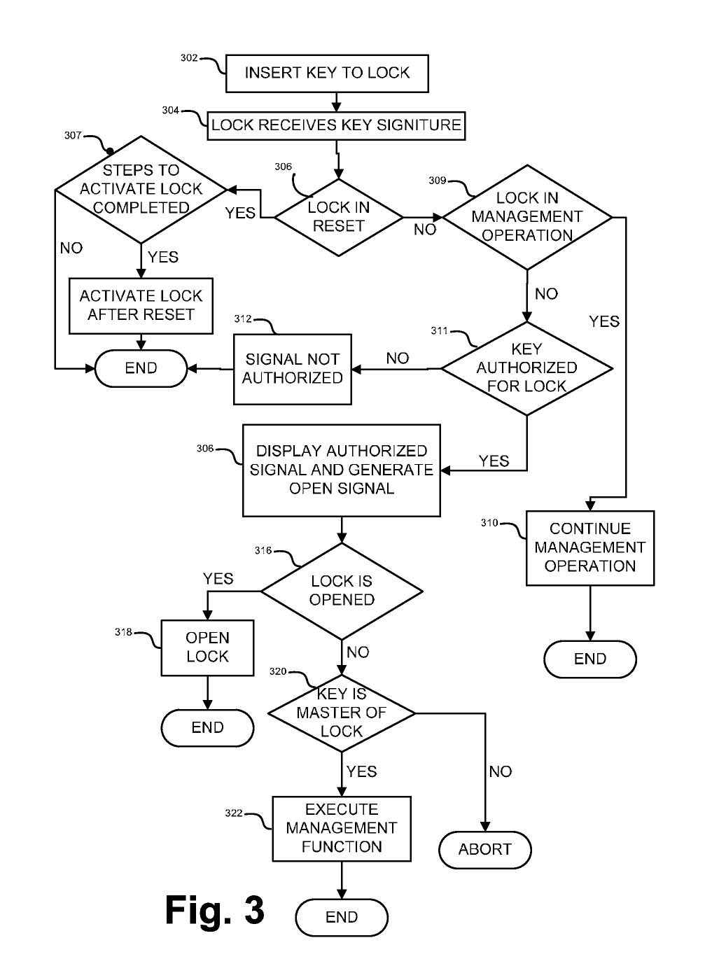

Referring now to FIG. 3, showing a flowchart of the main steps in an embodiment of a method for activating an electronic lock and key system. The process implemented by processor 106 of FIG. 1 comprises a finite state machine, which can assume three main states or modes, being: reset mode, in which no key can open the lock and no information is kept in tables 200, 204, 208 and 210 of the lock storage; normal mode in which the lock is during normal operation; and control mode, in which various control operations can be performed for the lock. Once in control mode, additional modes are reachable which enable the execution of multiple operations, such as authorizing a key, creating a disabler key, and the like. The various modes and control operations are further detailed below. embodiments for the determining and performing the control operations are detailed below. On step 302 a key is inserted into a keyway within a lock device, or otherwise introduced such that lock communication system and key communication system can communicate. In some exemplary embodiments, on optional step 303, electrical power is supplied by the power supply of the key to the lock. On step 304 the lock device retrieves the sequence of codes associated with the key, according to one of the schemes detailed in association with FIG. 2 above or a similar method. On step 306 it is determined whether the lock is in reset mode. The lock is in reset mode prior to its first use, or whenever it is reset and before it was re-activated. If the lock is in reset mode, on step 307 it is determined by lock processor 106 of FIG. 1 whether the actions required for activating the lock have been completed. If the actions were completed, on step 308 the lock is activated, and the key activating it becomes a master key and its signature is stored in table 200 of FIG. 2. Otherwise the system exits and the lock remains in reset mode. Lock signaling element 107 and key signaling element 126 preferably provide distinct indications when the lock is in reset mode, when the lock is activated after reset, and when an Open signal is sent. If on step 306 it is determined that the lock is not in reset mode, it is determined on step 309 whether the lock is in control mode. If the lock is in control mode, the control operation continues on step 310. Otherwise, if the lock is not in control mode, it is determined on step 311 whether the key is authorized for opening the lock device.

This is determined by comparing the sequence read from the key storage on step 304 to rows in the relevant tables or other data structures within the lock storage. If the key is not authorized, then a non-authorization signal is optionally sent to the signaling element 107 and optionally to key signaling element 126, and the process ends. If the key is authorized then on step 314 an open signal is sent to lock mechanic control 108 and the lock can be opened. In addition, authorized signals are optionally sent to lock signaling element 107 or to key signaling element 126. On step 316 it is determined whether the lock was indeed open. It will be appreciated by a person skilled in the art that opening the lock can be performed by a user through any activity required by the mechanism and enabled once the signal was sent, such as rotating a key, pushing a part, pulling a part, raising a part, lowering a part, or the like. If the lock was opened, on step 318 the lock state is set to normal and the process ends. Otherwise, it is determined on step 320 whether the key is a master key of the lock. This is again determined by comparing the sequence obtained on step 304 to a table carrying the number of master keys within the lock storage. If the key is not a master key, the process stops. If the key is a master key, on step 322 control mode is entered.

Reset mode is the initial mode of the lock device. In this mode the only process that can be executed is activating the lock device after reset, as referred to in step 308. Any key that can be assigned as a master key for this lock, which is by default every key unless defined otherwise, can be used to execute this process. When a process for activating the lock device after reset is completed, the lock device switches to normal mode. An example for a process to activate a lock after reset consists of inserting a key to the lock and then removing it and repeating this operation for 3 or another predetermined number of times.

Normal mode is the mode in which the lock system is generally in. In normal mode, when a key authorized to open the lock is inserted into the lock system the lock system executes an open operation. When a key not authorized to open the lock is inserted a reject open operation is performed. When a master key is inserted into the lock system when in normal mode, then if the master key is authorized to open the lock, the open lock process is performed, the lock transfers to control mode and control operations are enabled. If the master key is not authorized to open the lock, the lock only moves to control mode and control operations are enabled.

Control mode is the mode in which control operations are optionally executed. When the lock device moves to control mode, it remains in control mode for a predetermined time, and if no control operation takes place during that time, then when a key is inserted into the lock device it automatically switches to normal mode. If a key is inserted before the expiration of control mode period, and the inserted key is authorized for one or more operations, then the lock remains in control mode and the control function continues. When the control operation is completed, the lock switches to normal mode, unless the control operation was reset lock, in which case the lock switches to reset mode.

Lock open operation is executed when a key previously authorized to open a lock is inserted into the lock, when the lock is in normal mode. When the key is inserted, lock processor 106 sends requests through lock communication system 110, which then sends the request to key communication system 128, which reads data from key storage 124 based on the sent request. The result is transferred from key communication system 128 through lock communication system 110 back to lock processor 106. Lock processor 106 may issue multiple requests to access data from the key using the above described process. The data is then compared against the data in authorized keys table 204 or additional tables. If approved, processor 106 sends approve signals which are optionally displayed on key signaling element 126 or on lock signaling element 107. Processor 106 also generates an open signal and sends it to lock mechanic control 108. The open signal enables the user of the key to open the lock device with the key for a limited predetermined period of time.

Reject open operation takes place when a key inserted into a lock is not defined as authorized to open the lock 102. When the key is inserted and the lock is in normal mode, elements from the key storage are read as described in association with the open operation above. If the data does not fit any of the keys authorized for the lock, the lock sends a reject signal which optionally displayed on key signaling element 126 or on lock signaling element 107. No open signal is sent to lock mechanic control 108, so the lock can not be opened.

Each of the control operations detailed below is executed by a user performing a predetermined sequence of actions unique for each operation, including actions such as key insertions and lock open actions. For example, the reset lock operation may be initiated by repeating a sequence of inserting a key and removing it without opening the lock four times within 45 seconds, while authorizing a key to open the lock may be initiated by inserting a master key and opening the door, followed by inserting a different key. The combinations are determined by a manufacturer of the key and lock system, and are preferably delivered to a user of the system via a printed or a digitally provided user manual, in a web site, or in any other manner.

Reset lock operation is preferably accessible by a sequence of operations as discussed above. The result of the reset lock operation is that all data stored in the tables of the lock storage, excluding the read-only data characterizing the lock is erased and the lock device switches to reset mode. Reset lock operation is optional, and can be implemented or skipped.

Activating lock after reset operation is performed when the lock is in reset mode, i.e. no information is stored in the tables of the lock storage device. During the operation, processor 106 retrieves information from key storage 124 as described above, and stores the information in one or more tables of lock storage 104. Storing the information in master key table 200 will make the specific key a master key for the lock.

Authorizing a key to open the lock is also an optional operation. When enabled, the operation requires a master key of the lock and a second key that should be granted authorization to open the lock. The process preferably includes inserting the master key into the lock device one or more times, and optionally opening the lock device one or more times, followed by inserting the second key into the lock, optionally followed by one or more insertions of the master key to the lock or one or more openings of the lock. The authorization can be for a limited or unlimited number of times. The number of times can be limited by the person authorizing the key, for example by performing a predetermined operation or sequence of operations a predetermined number of times, or a number of times related to the number of times the key should be able to open the lock. The number of times is optionally stored together with the key sequence in a table stored in lock storage 104. Each time a key with times limitation is used to open the lock, the limit is decreased, and when the limit decreases to zero, the key is disabled, i.e. the row in authorized keys table 204 comprising the codes of the specific key is deleted from the table.

Authorizing an additional master key is an optional operation. The operation requires a master key of the lock and a second key that should be granted master authorization. The process includes a predetermined sequence of operations, such as inserting the master key into the lock device, optionally opening the lock device and optionally repeating the process or parts thereof one or more times, and optionally inserting again the two keys in a predetermined order. When the process is completed, the second key is authorized as a master key. This operation can be implemented as two different operations, one of which resulting in the original key losing its authorizations as a master key, i.e. its data being removed from master key table 200, and the other resulting in the two keys being authorized as master keys.

Authorizing a disabler key is also an optional operation. When the operation is enabled, it requires a user to have a master key of the lock, a second key being granted authorization to open the lock, and a third key granted authorization to disable the second key. The process includes a predetermined sequence of operations, such as inserting the master key into the lock device, optionally opening the lock device and optionally repeating the process or parts of it one or more times, followed by inserting the second key one or more times, followed by inserting the third key into the lock key one or more times, optionally followed by inserting the three keys again in a predetermined order. When the process is completed, the second key has authorization to open the lock, and the third key can be used, together with a master key, to disable the second key, when the need arises for example due to loss of the second key.

Disabling authorization of a key to open the lock is an optional operation. The disabling operation requires a master key of the lock and a second key that has been granted authorization to open the lock, wherein the authorization should be disabled. The process includes inserting the master key into the lock device, optionally opening the lock device and optionally repeating the process or parts thereof one or more times, followed by inserting the second key one or more times into the lock, and optionally inserting again the master key and the second key into the lock in a specific order. At the end of the process the key that was authorized cannot be used to open the specific lock anymore. The data related to the key is either deleted from authorized keys table 204 or added to disabled keys data 210.

Disabling authorization of a key to open the lock using a disabler key is an optional operation. When enabled, the operation requires a master key of the lock and a disabler key, which was earlier associated with the key to be disabled through the operation of authorizing a disabler key described above. The process includes inserting the master key into the lock, optionally opening the lock device and optionally repeating the process or parts thereof one or more times, followed by inserting the disabler key one or more times and optionally inserting again the master key and the disabler key in a specific order. At the end of the process the key associated with the disabler cannot be used to open the specific lock anymore.

In an embodiment, the process is performed by deleting from keys with disablers table 208 the row with the codes of the key associated with the disabler key. This operation is useful when the need rises for disabling a key, when the key to be disabled is not available.

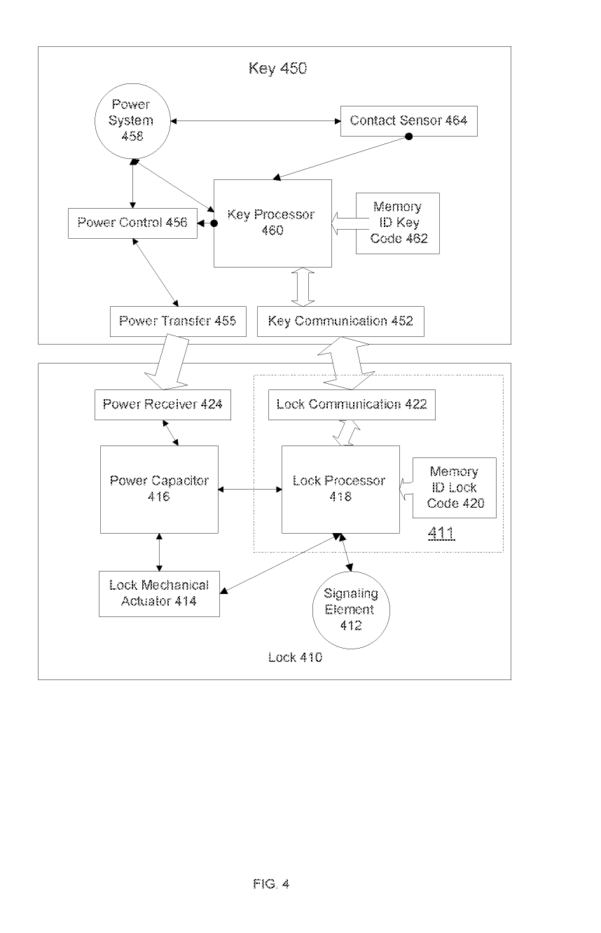

FIG. 4 illustrates a lock 410 and a key 450 according to an embodiment of the invention.

The lock 410 may include a power receiving circuit (power receiver) 424 arranged to receive from a key 450 power that facilitates an operation of the lock 410 during a lock activation period of a limited duration, wherein the supply of power is triggered by a detection (for example, by contact sensor 464 of key 450) of a proximity between the key 450 and the lock 410.

The lock 410 may also include a lock logic circuit 411, powered by power receiving circuit 424, and may be arranged to participate, during the lock activation period, in an execution of at least one operation out of a key management operation and a lock opening attempt.

The lock 410 further includes a lock mechanical module (such as a lock mechanical actuator 414) arranged to participate in a lock attempting attempt.

The lock activation period is short may not exceed few seconds, a minute, half a minute, 20 seconds, 10 seconds and the like. It is short enough to save energy and to activate the lock only when a key tries to open the lock but is long enough to allow a user to perform lock management operations or lock opening attempts.

The lock logic circuit 411 may be arranged to determine, based on information retrieved from the key 450 and information stored at the lock 410, whether the key 450 is authorized to open the lock; and allow the key to open the lock if determining that the key is authorized to open the lock.

The lock logic circuit 411 may be arranged to allow the lock mechanical module to be opened after the lock logic determined that the key is authorized to open the lock; wherein the lock mechanical module may be arranged to open the lock in response to a predefined movement of the key. For example—the lock logic circuit can instruct a clutch pin to connect between a enclosure that surrounds the keyhole and between a mechanical locking mechanism (if the key is an authorized key) so that turning the key in the keyhole will affect the mechanical locking mechanism and may open the lock—in a similar manner that turning a pure mechanical key in a prior art lock may open that prior art lock. Once the lock activation ends the connection is revoked and the keyhole is disconnected from the mechanical locking mechanism.

As indicated above, the lock logic circuit 411 may be arranged to instruct the lock mechanical module 413 to be mechanically linked to the key after determining that the key is authorized to open the lock 410.

The power receiving circuit 424 may be arranged to receive power from the key 450 by inductance. The power receiving circuit 424 can include an inductor that surrounds the key hole—it may have a cylindrical shape that defines a cylindrical space in which the key 450 can rotate.

The key management operation may be either one of resetting the lock, defining the key as a master key, defining another key as an additional master key, defining another key as an authorized key that is not another master key, revoking an authorization of another key to open the lock, revoking a definition of another key to be a master key.

The lock logic circuit may be arranged to initiate a key management selection operation by sensing that a key that is defined as a master key was inserted into a keyhole of the lock and removed from the key hole at least twice; wherein the key management selection operation may be either one of resetting the lock, defining another key as an additional master key, defining another key as an authorized key that is not another master key, revoking an authorization of another key to open the lock, revoking a definition of another key to be a master key,

The lock 450 may include a lock status indicator (such as a signaling element 412) arranged to provide a lock status indication by the lock 450, wherein the lock status indication may be either one of an audio lock status indication and a visual lock status indication. For example—the color of light emitted and the manner in which it is emitted (continuous or pulsed manner) may indicate whether the lock is reset, is programmed (thus there is a master key, whether the lock operated in a programming mode (lock management operation is being executed), whether a lock opening attempt failed, whether a lock opening attempt succeeded, low battery, and the like.

The lock may include a power reservoir (such as power capacitor 416) arranged to power the lock logic circuit 411 (and even the lock mechanical portion) after a termination of a supply of power from the key and during the lock activation period.

The key 450 is illustrated as including a power system (such as a battery 458), a contact sensor 464 or a proximity sensor for detecting that the key 450 and the lock are close to each other, a power control circuit 456 arranged to control the supply of power to the lock 410 so that the power will enable the lock 450 to operate during the lock activation period, a power transfer circuit 455 for transferring the power to the lock, a key communication circuit 452 for communicating with the lock 410, a memory ID key code 462 for storing information such as key identifier information and a key processor 460 for controlling the key, transferring information to the lock, participating in a key authentication process and the like.

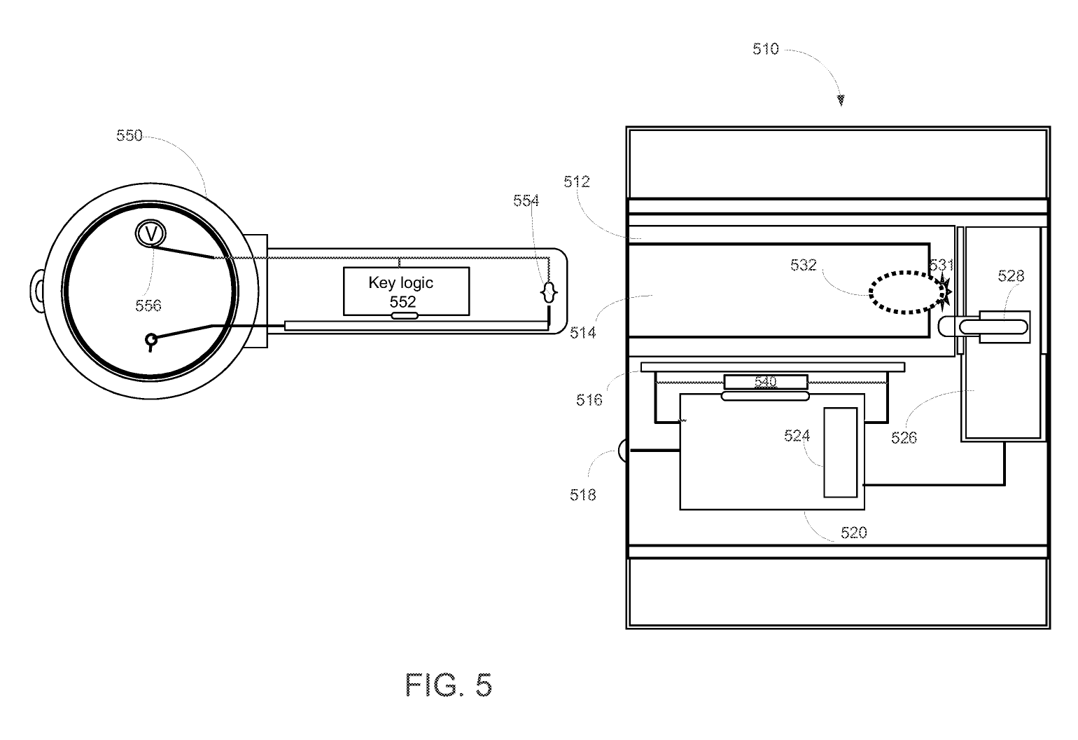

FIG. 5 illustrates the lock 510 and the key 550 according to another embodiment of the invention. The lock includes a power supply 556, key logic 552 and a proximity sensor 554. The key logic 552 can include a processor, a memory module and a communication module. The proximity sensor 554 is arranged to sense an electromagnetic field 532 that may be very weak so as to be sensed only when the key 550 and the lock 510 are proximate to each other and once sensing the proximity—provide a proximity indication (for example—by interrupting the processor of the key logic) that may activate the key logic and allow the key to function and power the lock during the lock activation period.

The lock is shown as having a lock processor 520 that include a lock memory 524, a signalling circuit 518, a power reservoir 540, a power receiver 516, a lock mechanical actuator 526 that includes a latch 528 that can be moved towards a keyhole enclosure 532 in order to provide a mechanical link between the keyhole enclosure 512 and the lock mechanical actuator 526.

The lock also includes a weak electromagnetic source 531 that can provide the weak electromagnetic field 532. The proximity sensor 554 is arranged to sense an electromagnetic field 532 that may be very weak so as be sensed only when the key enters the keyhole.

The signalling circuit 518 can generate audio and/or visual indicators. It, can, for example, provide the following indications, wherein these indications can be provided as a result of an insertion of a key to the lock and may terminate either when another indication shall be provided or when the lock activation period ends:
i. Blink in red—when the lock is reset. The blinking can occur during each insertion of key to the lock—until a lock is programmed
ii. Continuous red—when an un-authorized key attempts to open the lock or when a previously authorized key is successfully un-authorized.
iii. Blinking green—when an insertion of a key causes the lock to enter a programming mode.
iv. Continuous green—when a key is authorized as a master key and the lock is regarded to be programmed, after the lock entered the programming mode and is being programmed, when an authorized key attempts to open the lock. This indication may be provided at the last insertion of a key that is now defined as a master key. This can also be provided when an authorized key is first inserted to the lock (authentication is completed);

For example, when a new key is defined as an (additional) master key then (i) during the authentication stage {the master key is inserted} a continuous green indication is provided, (ii) when entering a programming mode {the master key is inserted again} a blinking green indication is provided, and (iii) when programming the lock {the additional key to be defined as an additional master key is inserted} a continuous green indication is provided.

For example, a master key can authorize any other key to operate the lock in a process in which the two keys are used. This may include: (i) Inserting a master key—light is green. The master key is then removed it without operating the Lock. (ii) Inserting the master key again—green light blinks (programming mode—authorization). Removing it without operating the Lock, and (iii) Inserting a key to be authorized—green light on. Key is authorized. The key becomes a user key of the lock.

It is noted—if the sequence was interrupted or the lock was operated then the process must be executed from the first step.

An authorized key (master key or user key) can open the lock. This may include: (i) Inserting authorized key—light is green. (ii) Operating the lock—green light still on. It is noted—the lock operation is available for few seconds. If the operation was not performed during the time frame then key has to be re-inserted (step 1).

An un-authorized key cannot open the lock. (A) Inserting an un-authorized key—light is red. Neutral Revolution—Lock is not operated—not opened.

A master key can authorize any other authorized key (user key) to become a Master key. This may include: (i) Inserting a master key—light is green. Remove it without operating the Lock. (ii) Inserting master key again—green light blinks (programming mode—authorization). Remove it without operating the Lock. (iii) Inserting an Authorized key (a user key) to become a Master key—green light on. Authorized (user) key becomes a Master key.

It is noted: if the sequence was interrupted or the lock was operated then the process must be executed from step 1.

A master key can un-authorize any other authorized key in a process in which the two keys are used. This may include: (i) Inserting the master key—light is green. Remove it without operating the Lock (ii) Inserting the master key again—green light blinks (programming mode—authorization). Remove it without operating the Lock. (iii) Inserting the master key again—green light blinks (programming mode—removal). Remove it without operating the Lock, and (iv) Inserting the authorized key to be un-authorized—red light on. Key is un-authorized.

Note: if the sequence was interrupted or the lock was operated then the process must be executed from step 1.

A master key can reset the lock This may include: (i) Inserting the master key—light is green. Remove it without operating the Lock; (ii) Inserting the master key again—green light blinks (programming mode—authorization). Remove it without operating the Lock. (iii) Inserting the master key again—green light blinks (programming mode—removal). Remove it without operating the Lock. (iv) Inserting the master key again (4^{th})—green light blinks (programming mode—reset). Remove it without operating the Lock. (v) Inserting the master key again (5^{th})—red light blinks—Lock is Reset.

Note: if the sequence was interrupted or the lock was operated then the process must be executed from step 1.

A master key can create a cancellation key to any other authorized key in a process in which the three keys are used. This may include: (i) Inserting the master key—light is green. Remove it without operating the Lock. (ii) Inserting the master key again—green light blinks (programming mode—authorization). Remove it without operating the Lock. (iii) Inserting the master key again (3^{rd})—green light blinks (programming mode—removal). Remove it without operating the Lock (iv) Inserting the Cancellation key—green light on—Cancellation key recorded in lock memory. (v) Inserting the User key—green light on—User key linked to the Cancellation Key.

Note: Cancellation key cannot be an Authorized key (user key) otherwise it will remove (un-Authorized) at step 4. Also a Cancellation key cannot be authorized to become a user key of the lock.

A master key can un-authorize an authorized key (user key) in a process in which a cancellation key of that specific user key is used. This can include: (i) Inserting the master key—light is green. Remove it without operating the Lock. (ii) Inserting the master key again—green light blinks (programming mode—authorization). Remove it without operating the Lock. (iii) Inserting the master key again (3^{rd}-green light blinks (programming mode—removal). Remove it without operating the Lock. (iv) Inserting the Cancellation key—red light on—The linked user key removed (un-Authorized). Cancellation key record is erased from lock memory.

Note: if the sequence was interrupted or the lock was operated then the process must be executed from step 1.

A master key can enable a use of a control unit such as a Key-Pad for monitoring lock logs and for programming the lock. This may include: (i) Inserting the master key—light is green. Remove it without operating the Lock. (ii) Inserting the master key again—green light blinks (programming mode—authorization). Remove it without operating the Lock. (iii) Inserting the Key-Pad—green light blinking during the whole time of the Key-Pad operation.

Note: Key-Pad may not operate the Lock; it may be used for monitoring and programming the Lock.

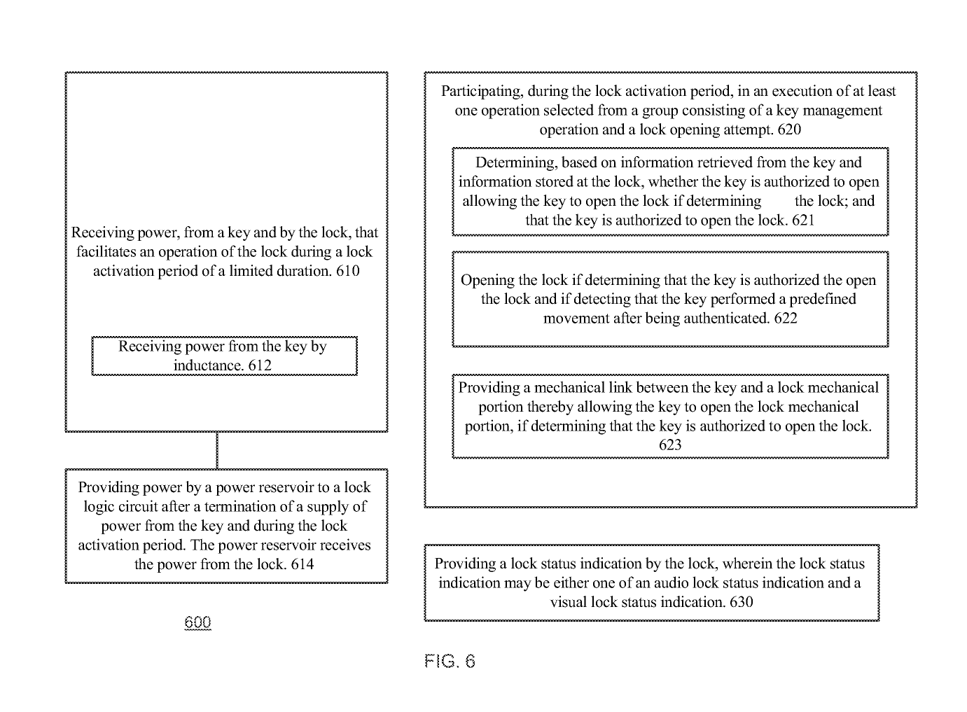

FIG. 6 illustrates a method 600 for opening a lock according to an embodiment of the invention.

Method 600 starts by stage 610 of receiving power, from a key and by the lock, the power facilitates an operation of the lock during a lock activation period of a limited duration.

The power can be provided during the entire lock activation period. Alternatively, the power is provided during a portion of the lock activation period but the lock has a power reservoir that is charged during that portion and can supply power until the lock activation period ends.

Stage 610 may include stage 612 of receiving power from the key by inductance.

Stage 610 may be followed by stage 614 providing power by a power reservoir to a lock logic circuit after a termination of a supply of power from the key and during the lock activation period. The power reservoir received the power from the lock.

Stage 610 may be executed almost in parallel to stage 620 of participating, during the lock activation period, in an execution of at least one operation selected from a group consisting of a key management operation and a lock opening attempt. Stage 620 may start after the beginning of a reception of power by the lock.

The lock activation period is short and may not exceed few seconds, a minute, half a minute, 20 seconds, 10 seconds and the like.

Stage 620 may include stage 621 of determining, based on information retrieved from the key and information stored at the lock, whether the key is authorized to open the lock; and allowing the key to open the lock if determining that the key is authorized to open the lock.

Stage 620 may include stage 622 of opening the lock if determining that the key is authorized the open the lock and if detecting that the key performed a predefined movement after being authenticated.

Stage 620 may include stage 623 of providing a mechanical link between the key and a lock mechanical portion thereby allowing the key to open the lock mechanical portion, if determining that the key is authorized to open the lock.

Stage 620 may include a executing a key management operation that may be either one of resetting the lock, defining the key as a master key, defining another key as an additional master key, defining another key as an authorized key that is not another master key, revoking an authorization of another key to open the lock, revoking a definition of another key to be a master key.

Stage 620 may include initiating a key management selection operation by sensing that a key that is defined as a master key was inserted into a keyhole of the lock and removed from the key hole at least twice; wherein the key management selection operation may be either one of resetting the lock, defining another key as an additional master key, defining another key as an authorized key that is not another master key, revoking an authorization of another key to open the lock, revoking a definition of another key to be a master key.

The method may include stage 630 of providing a lock status indication by the lock, wherein the lock status indication may be either one of an audio lock status indication and a visual lock status indication. Stage 630 may be executed in parallel to stage 610 and 620.

Non-limiting examples of operations that can be executed by the key and the lock may include: (a) activating an un-programmed lock by a key; (b) defining a key as a master-key of the lock; (c) authorization of new keys by the master-key; (d) opening the lock by an authorized key; (e) rejecting an opening attempt by an Un-Authorized Key; (f) defining an Authorized Key to as a Master-Key; (g) Un-authorizing an Authorized Key (removal); (h) resetting the Lock by a Master-Key (Lock becomes Un-Programmed Lock); (g) programming the lock (by a control unit). Most of the examples were illustrated in the text above.

The activation of a lock—the defining of a key as a master can include repetitively (a) inserting a key into a key hole of a reset lock, and (b) pulling the key out of the keyhole multiple (N) times (for example—without trying to open the lock by rotating the key). This can include repeating this session three times. The first (N-K) (for example two) repetitions are used to enter the lock logic to a key management mode. If the keys are switched during the sequence—the sequence resets and starts from the first step of the sequence.

Assuming, for example, that there are three iterations (N=3) then the signalling

Insert a key—Red light is blinking to indicate Un-Programmed lock.

Insert same key 2nd time—Red light still blinking

Insert same key 3rd time—Green light turns on.

The definition of another key as a master key can include repetitively (a) inserting a master key into a key hole of a programmed lock, and (b) pulling the master key out of the keyhole multiple times (for example—without trying to open the lock by rotating the key) and then inserting the other key into the keyhole and pulling that key out of the keyhole one or more times to define the other key as another master key. This can include repeating this insertion and pulling of the master key once and then inserting and pulling the other key once.

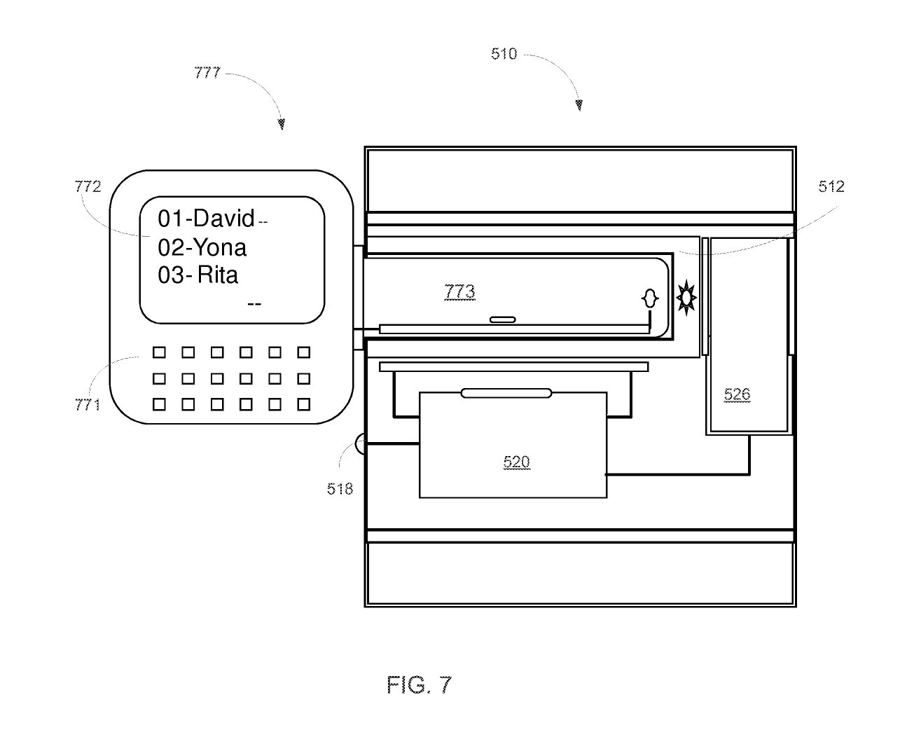

FIG. 7 illustrates a control unit 777 that can program the lock, and retrieve data stored in the lock. The control unit 777 may have a keypad 771, and/or a small display 772, or any other interfacing element. The control unit 777 may have a body 773 that fits to the lock hole of the lock. The body may supply power to the lock during a period that is longer than the lock activation period (as defined by a master key or an authorized key)—in order to enable more lengthy operations such as programming the lock and the like. The programming can include writing key identifiers and optionally additional key attributes for keys that should be authorized (by the control unit) to unlock the lock. The control unit 777 may retrieve a log of lock/unlock operations that may be stored at the lock. The control unit 777 may be authorized by a master key before being able to interact with the lock.

Yet according to an embodiment of the invention the master key can authorize a keypad or other information interface to exchange information with the lock, to program the lock and the like.

According to an embodiment of the invention the power may be supplied by the lock and the various illustrated above methods and components may be applied mutatis mutandis to this power supply manner.

For example, the lock may include a power providing circuit arranged to provide to a lock power that facilitates an operation of the key and the lock during a lock activation period of a limited duration, wherein the supply of power is triggered by a detection of a proximity between the key and the lock; a lock logic circuit, arranged to participate, during the lock activation period, in an execution of at least one operation selected from a group consisting of a key management operation and a lock opening attempt; and a lock mechanical module arranged to participate in a lock attempting attempt. Yet for another example, the method may include supplying power to a key that facilitates an operation of the key and of the lock during a lock activation period of a limited duration; and participating, during the lock activation period, in an execution of at least one operation selected from a group consisting of a key management operation and a lock opening attempt.

The lock and key system and method overcome the disadvantages of the prior art. The system and method utilize read-only storage on the key, and read-only storage on the lock, uniquely indicating which items should be read from the key storage, and read-write storage on the lock, storing information related to one or more keys and their respective authorizations. The reading creates unique information characterizing the specific key and specific lock combination. Thus, a single key can be used for activating multiple lock, and can further have different authorizations for different locks. Thus, the same key can be a master key for one lock, a regular key for another lock, a disabler key for a thirds lock, or a disabled key for a fourth lock.

The system and method thus enable cheap, easy to use, and secure key management. Additional authorized keys for a lock can be created without any equipment beyond the key and lock, additional master keys can be created, and keys can be disabled with or without having the keys themselves. A key can be authorized to open a lock only a limited number of times after which it becomes disabled. A lock can further be reset to disable all keys at once. Another advantage of the disclosed system and method is that a single key can be authorized to open or to be a master key for multiple locks, so that a person need only carry one key, which will open all locks the person needs, such as his home, car, bike, closet, desk drawers and others. Since power supply for the component of the system is received from a power source located on each key, no electrical or data wiring is required to reach the lock, thus enabling the electric lock and key system to be used anywhere, including in stationary locations such as offices, hotels, home, or others, as well as in mobile locations, such as car, bike, closets or the like.

A person skilled in the art will appreciate that various alternative embodiments exist to the disclosed method and apparatus. For example, supplying electrical power to the lock, and using wireless communication components for the lock and the key will enable wireless communication between the lock and the key, provided the lock and the key are placed in such distance as to enable such communication. In another embodiment, the key or another opening element can be replaced with a biometric measure of a user, such as a fingerprint or an iris print. Thus, instead of reading numbers from the key storage, lock processor 106 will determine a number or a process and will retrieve and digitize, for example by scanning, one or more characteristic features of the relevant body part according to the number or algorithm particular to the lock, thus generating the signature of the body part in association with the lock. The lock will store the result when a person is authorized to open the lock or to authorize other persons to open the lock, or compare to pre-stored signatures. For example, the digitized read characteristic is multiplied by a number stored on the lock storage. Processor 106 will compare the read biometric measures and compare them to stored ones when an attempt to open the lock or perform a control operation is made. In yet another embodiment, the opening element will be a keypad attached to the lock, so that the lock will be opened (or an additional combination will become allowed, or another control operation will take place) if a combination of numbers which was pre-stored within the lock storage matches the numbers hit on the keypad. The initial number for activating the lock may either be pre-stored with the lock or entered on the first activation. In yet another embodiment, the opening element can comprise a combination of two or more elements including a keypad, a body part or a key having a storage. The two elements may be of different types or of the same type, such as two keys, an iris print and a fingerprint, or the like

It will be appreciated by a person skilled in the art that the disclosed methods and apparatus are not limited to opening a lock. Thus, such apparatus and method can also be used to limit any action, including closing a lock, starting or stopping an operation such as starting or stopping an engine, or any other activity that should be enabled only when a mechanism preventing it has determined that a legitimate opening element was introduced.

It will be further appreciated that the lock can be activated by energy types other than electric energy, such as electro-magnetic energy or others.

While embodiments of the disclosed subject matter have been described, so as to enable one of skill in the art to practice the disclosed subject matter. The preceding description is intended to be exemplary only and not to limit the scope of the disclosure to what has been particularly shown and described hereinabove. The scope of the disclosure should be determined by reference to the following claims.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A lock, comprising:
A power receiving circuit arranged to receive from a key power that facilitates an operation of the lock during a lock activation period of a limited duration, wherein the supply of power is triggered by a detection of a proximity between the key and the lock;
A lock logic circuit, powered by power receiving circuit, arranged to participate, during the lock activation period, in an execution of at least one operation selected from a group consisting of a key management operation and a lock opening attempt; and a lock mechanical module arranged to participate in a lock attempting attempt.

2. The lock according to claim 1, wherein a duration of the lock activation period does not exceed 20 seconds.

3. The lock according to claim 1, wherein the lock logic circuit is arranged to determine, based on information retrieved from the key and information stored at the lock, whether the key is authorized to open the lock; and allow the key to open the lock if determining that the key is authorized to open the lock.

4. The lock according to claim 3, wherein the lock logic circuit is arranged to allow the lock mechanical module to be opened after the lock logic determined that the key is authorized to open the lock; wherein the lock mechanical module is arranged to open the lock in response to a predefined movement of the key.

5. The lock according to claim 3, wherein the lock logic circuit is arranged to instruct the lock mechanical module to be mechanically linked to the key after determining that the key is authorized to open the lock.

6. The lock according to claim 1, wherein the power receiving circuit is arranged to receive power from the key by inductance.

7. The lock according to claim 1, wherein the key management operation is selected from a group consisting of resetting the lock, defining the key as a master key, defining another key as an additional master key, defining another key as an authorized key that is not another master key, revoking an authorization of another key to open the lock, revoking a definition of another key to be a master key.

8. The lock according to claim 1, wherein the lock logic circuit is arranged to initiate a key management selection operation by sensing that a key that is defined as a master key was inserted into a keyhole of the lock and removed from the key hole at least twice; wherein the key management selection operation is selected from a group consisting of resetting the lock, defining another key as an additional master key, defining another key as an authorized key that is not another master key, revoking an authorization of another key to open the lock, revoking a definition of another key to be a master key.

9. The lock according to claim 1, comprising a lock status indicator arranged to provide a lock status indication by the lock, wherein the lock status indication is selected from a group consisting of an audio lock status indication and visual lock status indication.

10. The lock according to claim 1, wherein the lock comprises a power reservoir arranged to power the lock logic circuit after a termination of a supply of power from the key and during the lock activation period.

11. A method for opening a lock, the method comprises:
Receiving, from a key and by the lock, that facilitates an operation of the lock during a lock activation period of a limited duration; and
Participating, during the lock activation period, in an execution of at least one operation selected from a group consisting of a key management operation and a lock opening attempt.

12. The method according to claim 11, wherein a duration of the lock activation period does not exceed 20 seconds.

13. The method according to claim 11, wherein the lock opening attempt comprises:
Determining, based on information retrieved from the key and information stored at the lock, whether the key is authorized to open the lock; and
Allowing the key to open the lock if determining that the key is authorized to open the lock.

14. The method according to claim 11, comprising opening the lock if determining that the key is authorized to open the lock and if detecting that the key performed a predefined movement after being authenticated.

15. The method according to claim 11, comprising providing a mechanical link between the key and a lock mechanical portion thereby allowing the key to open the lock mechanical portion, if determining that the key is authorized to open the lock.

16. The method according to claim 11, comprising receiving power from the key by inductance.

17. The method according to claim 11, wherein the key management operation is selected from a group consisting of resetting the lock, defining the key as a master key, defining another key as an additional master key, defining another key as an authorized key that is not another master key, defining another key as an authorized key that is not another master key, revoking an authorization of another key to open the lock, revoking a definition of another key to be a master key.

18. The method according to claim 11, comprising initiating a key management selection operation by sensing that a key that is defined as a master key was inserted into a keyhole of the lock and removed from the key hole at least twice; wherein the key management selection operation is selected from a group consisting of resetting the lock, defining another key as an additional master key, defining another key as an authorized key that is not another master key, revoking an authorization of another key to open the lock, revoking a definition of another key to be a master key.

19. The method according to claim 11, comprising providing a lock status indication by the lock, wherein the lock status indication is selected from a group consisting of an audio lock status indication and a visual lock status indication.

20. The method according to claim 11, comprising providing power by a power reservoir to a lock logic circuit after termination of a supply of power from the key and during the lock activation period.

21-54. (canceled)
